(19) United States
(12) Patent Application Publication
(10) Pub. No.: US 2021/0066928 A1
(43) Pub. Date: Mar. 4, 2021

(54) INPUT VOLTAGE ADAPTED POWER CONVERSION

(71) Applicant: SIGNIFY HOLDING B.V., EINDHOVEN (NL)

(72) Inventors: Goutam MAJI, EINDHOVEN (NL); Christian HATTRUP, EINDHOVEN (NL); Harald Josef Günther RADERMACHER, EINDHOVEN (NL); Matthias WENDT, EINDHOVEN (NL)

(21) Appl. No.: 16/962,371

(22) PCT Filed: Jan. 9, 2019
(86) PCT No.: PCT/EP2019/050438

§ 371 Date: Jul. 15, 2020

(30) Foreign Application Priority Data
Jan. 18, 2018 (IN) 201841002093
Mar. 5, 2018 (EP) 18159844.2

(51) Int. Cl. H02J 7/00; H02J 7/34

(52) U.S. Cl. CPC H02J 7/0013; H02J 7/0048; H02J 2207/20; H02J 7/345; H02J 2207/50; H02J 7/007182

(57) ABSTRACT

The present invention relates to a functional device (10A) with improved power conversion efficiency. The functional device (10A) comprises a functional unit (12), two or more energy storage units (14A, 14B, 14C, 14D), and an electric power converter unit (16). The electric power converter unit (16) is configured to receive an input voltage from an external power source (20) and to provide converted input voltage to a charging set (28A) of the energy storage units (14C, 14D) which are connected in series with each other having a charging set voltage adapted to the input voltage received from the external power source (20). A discharging set (32A) of the energy storage units (14A, 14B) is configured to provide an output voltage adapted to a functional unit input voltage required by the functional unit (12) to the functional unit (12). This allows an improved power conversion efficiency.

### FIELD OF THE INVENTION

The present invention relates to a functional device, a functional system, a method for operating the functional device, a computer program for operating the functional device, and a computer-readable medium having stored the computer program. In particular the present invention relates to a functional device such as a lighting device, an actuation device, a heating device, a cooling device, a temperature regulating device or any other functional device, with efficient power conversion.

### BACKGROUND OF THE INVENTION

US 2012/0319477 A1 shows a lighting system utilizing electricity from an electrical energy storage system and alternative energy sources. The lighting system has a controller configured to select an electrical power source from a plurality of electrical power sources based on which of the electrical power sources is the least expensive at that time. The electrical energy storage system comprises first and second electrical energy storage media. Each of the storage media can have one or more batteries. A number N of said batteries can be arranged in series such that the series has a voltage N×V and the batteries can be connected to conductors and switches that enable a first subset of said batteries to provide electricity at a first voltage less than N×V. The batteries can furthermore be connected to a second set of conductors and switches configured to charge batteries other than the first subset of batteries. The second subset of said batteries can provide electricity at second voltage not equal to the first voltage. The first subset of batteries can provide a voltage suitable for DC lighting and the second subset of batteries can provide a voltage sufficient to run a DC motor.

U.S. Pat. No. 6,342,775 B1 discloses a battery switching circuit which provides a mechanism by which a plurality of electrical storage batteries can be alternatively connected in parallel or series based on the position of a manually controlled joystick of a marine positioning and maneuvering system. When the joystick is in a neutral position, the storage batteries are connected in parallel for charging and when the joystick is moved out of its neutral position, the batteries are immediately connected in series to provide power to a plurality of electric motors that are used to drive a plurality of impellers of the docking system.

US 2006/122655 A1 discloses a high-energy power source with low internal self-discharge for implantable use includes a multiplicity of rechargeable energy storage battery cells, a primary power source adapted to charge the energy storage cells, a switching system adapted to switch the energy storage cells between a parallel connection configuration for charging and a series connection configuration for discharging, and circuitry adapted to initiate charging of the energy storage cells only in response to an input signifying a need to discharge energy and to refrain from charging the energy storage cells until the input is received.

### SUMMARY OF THE INVENTION

It can be seen as an object of the present invention to provide a functional device, a functional system, a method for operating the functional device, and a computer program for operating the functional device which allow a more efficient power conversion.

In a first aspect of the present invention a functional device is presented. The functional device comprises a functional unit, two or more energy storage units, and an electric power converter unit. The functional unit is configured to perform a function. The two or more energy storage units are configured to store electrical energy. The electric power converter unit is configured to be connected to an external power source, to receive an input voltage from the external power source and to provide converted input voltage to a charging set of the energy storage units which are connected in series with each other having a charging set voltage adapted to the input voltage received from the external power source in order to minimize a voltage difference between the input voltage and the converted input voltage. A discharging set of the energy storage units is configured to provide an output voltage adapted to a functional unit input voltage required by the functional unit to the functional unit in order to minimize a voltage difference between the output voltage and the functional unit input voltage.

Since the charging set voltage is adapted to the input voltage of the external power source, i.e., the charging set voltage is below and as close as possible to the input voltage based on the voltage of each of the energy storage units, a power conversion efficiency loss due to a difference of input voltage and converted input voltage of the electric power converter unit can be reduced. Furthermore since the discharging set is configured to provide output voltage adapted to the functional unit input voltage to the functional unit, i.e., the output voltage provided by the discharging set is above and as close as possible to the functional unit input voltage based on the voltage of each of the energy storage units, power conversion efficiency loss due to a difference of output voltage and functional unit input voltage can be reduced. Hence the functional device allows a more efficient power conversion.

The charging set can comprise all energy storage units or a subset of the energy storage units. The number of energy storage units in the charging set can be smaller than, larger than, or equal to the number of energy storage units in the discharging set. Preferably the number of energy storage units in the charging set is larger than the number of energy storage units in the discharging set. The power conversion efficiency is maximized if the ratio of input voltage to converted input voltage is close to one. A large difference between input voltage of the external power source and the functional unit input voltage may cause the power conversion efficiency to be reduced. The number of energy storage units in the charging set may be different from the number of energy storage units in the discharging set. This allows to keep the ratio of input voltage to converted input voltage close to one, because the charging set has a voltage adapted to the input voltage received from the external power source and at the same time the discharging set has an output voltage adapted to a functional unit input voltage required by the functional unit. The discharging set of the energy storage units can comprise one or more energy storage units. The energy storage units of the discharging set of the energy storage units are connected in series with each other if the discharging set comprises two or more energy storage units. In an embodiment, all the energy storage units may have the same voltage rating, meaning that each energy storage unit may individually be charged with substantially the same charging voltage and discharges at substantially the same discharging voltage. In an alternate embodiment, one or more or all of the energy storage units may have different voltage ratings.

The electric power converter unit is configured to convert electrical energy from one form to another. Electrical energy can be stored in various forms, e.g., in an electrical energy signal as alternating current (AC) or direct current (DC). The signal storing the electrical energy, i.e. the electrical energy signal, can for example be converted from AC to DC, a voltage level of the electrical energy signal can be changed to another voltage level, and/or a frequency of the electrical energy signal can be changed to another frequency. This allows to power the functional device with electrical energy from various external power sources. For example in case of conversion of AC voltage to DC voltage AC input voltage can be converted to DC input voltage with a AC to DC conversion factor. The AC to DC conversion factor depends on rectification, capacitor filtering, and electric power converter unit duty cycle.

The electric power converter unit can comprise a buck converter, a boost converter, or a buck and a boost converter. The electric power converter unit can be a switch mode power supply (SMPS). The SMPS is an electronic power supply comprising a switching regulator for efficiently converting electrical energy. The SMPS allows an efficient power conversion. Maximum power conversion efficiency of the SMPS can be achieved if the ratio of input voltage to converted input voltage is close to one. The SMPS can comprise a power factor correction (PFC) converter. The PFC allows to provide a higher power factor and to reduce current harmonics. The power factor is the ratio of real power and apparent power in the functional device. Current harmonics can for example be caused if non sinusoidal current is drawn from an external power source providing sinusoidal current.

The external power source can for example be a utility grid, a mains electrical power supply, a solar power source, a wind turbine power source, a water power source, a biomass power source, or any other external power source. For example for an external power source in form of the mains electrical power supply which provides 120 V AC input voltage the AC input voltage after rectification and capacitor filtering corresponds to 1.414·120 V DC input voltage, i.e. 170 V DC and if the electric power converter unit duty cycle for charging is 90%, 120 V AC input voltage correspond to 153 V DC input voltage. The functional device can in this case for example comprise a charging set of twelve 12 V energy storage units connected in series corresponding to 144 V DC. Therefore, when a minimization of a voltage difference between the input voltage and the converted input voltage is considered for the case of AC external power source, a rectified DC voltage is used as input voltage for said minimization. For example, for an external power source which provides 240 V DC input voltage, the functional device can comprise a charging set of twenty 12 V energy storage units corresponding to 240 V DC. The functional device can in these two cases comprise twelve, respectively twenty 12 V energy storage units. Alternatively the functional device can also comprise more than twelve, respectively twenty 12 V energy storage units, e.g. 15, respectively 25 energy storage units.

The output voltage of the discharging set can for example be 24 V for a functional unit requiring 24 V. The 24 V can for example be provided by a discharging set of two 12 V energy storage units connected in series. In case that the functional unit requires 40 V, the output voltage can be provided by a discharging set of 4 energy storage units, such that an output voltage of 48 V is provided which is the amount of voltage that is above and closest to the required voltage that is available from the energy storage units. The functional unit input voltage required by the functional unit may for example be a forward voltage of a light emitting diode (LED), i.e. an amount of volts the LED requires to conduct electricity and light up.

The functional device allows an operation at high power conversion efficiency for large difference between input voltage of the external power source and the functional unit input voltage, as the input voltage from the external power source is distributed to a charging set of the energy storage units while a discharging set of the energy storage units is used to power the functional unit with output voltage adapted to the functional unit input voltage. This allows to avoid high step down ratio, such as 10, as known from the prior art and therefore allows improving power conversion efficiency. Furthermore the functional device allows the electric power converter unit and the functional unit to operate at different voltage and power levels.

The functional device can comprise electric circuitry for connecting the functional unit, the energy storage units and the electric power converter unit. The electric circuitry can comprise electronic circuitry. The functional device can furthermore comprise an arrangement of switches. The arrangement of the switches can be configured to form the charging set, the discharging set, or the charging set and the discharging set of the energy storage units in dependence of open and closed states of the switches. The switches can for example be solid state switches or relay switches.

A passive state of the switches can be selected to require only minimum activation energy for a typical application, e.g. charging of the charging set or discharging of the discharging set. This allows to reduce energy consumption. The arrangement of the switches can furthermore comprise one or more diodes in order to reduce complexity of controlling the arrangement of the switches. The arrangement of the switches can comprise bistable relay switches. This allows to further reduce energy consumption.

The functional device can comprise a control unit. The control unit can be configured to control switching of the switches in order to form the charging set in dependence of the input voltage received from the external power source, the discharging set in dependence of the functional unit input voltage required by the functional unit, or the charging set and the discharging set of the energy storage units in dependence of the input voltage received from the external power source and the functional unit input voltage required by the functional unit. The control unit can comprise a processing unit, e.g. a processor for performing calculations, processing signals, or the like.

The control unit can be connected to the switches based on wires or wireless in order to control the arrangement of the switches. The control unit can comprise a transceiver for controlling the switches of the arrangement of the switches wirelessly. The control unit can be configured to transmit control signals via the transceiver for controlling the switches of the arrangement of the switches. The switches can comprise a transceiver for receiving control signals of the control unit and can be controlled in dependence of the control signals, i.e., the switches can be switched between an open and closed state such that either electric circuit is open or closed. The arrangement of the switches can for example comprise electromechanical relays. The electromechanical relays can comprise a coil for controlling a number of the switches simultaneously. The coil can be connected to a transceiver for receiving control signals of the control unit in order to switch the electromechanical relay. The relay logic can for example be implemented for charging the charging set or discharging the discharging set, i.e., normally open (NO) and normally closed (NC) switches can be arranged such that either the stable state of the relay is such that the energy storage units are charged or discharged. Alternatively the relay logic can also be implemented such that charging and discharging of the energy storage units is performed simultaneously.

The control unit can be configured to determine the input voltage received from the external power source, the functional unit input voltage required by the functional unit, or the input voltage received from the external power source and the functional unit input voltage required by the functional unit in order to control the switching of the switches. This allows a higher flexibility for connecting the functional device with various external power sources and for operating the functional unit. The functional unit can for example have various modes of operation that use different electronic components of the functional unit, such that a different functional unit input voltage is required in dependence of the mode of operation of the functional unit.

The control unit can be configured to form the charging set with a number of energy storage units connected in series such that the charging set voltage is below and as close as possible to the input voltage received from the external power source. The external power source can provide an input voltage of for example 110 V to 120 V, such as 120 V, 230 V to 240 V, such as 230 V or 277 V. In case that the energy storage units have equal voltage, e.g. 12 V, and the external power source provides 120 V, the control unit would form the charging set with ten energy storage units resulting in 120 V, i.e. about 120 V, as the voltage provided by the external power source needs to be larger than the voltage of the charging set which is either due to a lower initial voltage and increasing voltage of the charging set due to the charging or can also be a small voltage difference between the voltage of the charging set and the external power source, such as for example 0.1 V. The control unit would also form the charging set with ten energy storage units resulting in 120 V in case that the external power source provides between 120 V and 131 V.

The control unit can be configured to form the discharging set with a number of energy storage units such that the output voltage of the discharging set is above and as close as possible to the functional unit input voltage. If the discharging set comprises two or more energy storage units, the control unit is configured to form the discharging set with energy storage units connected in series.

The control unit can be configured to determine a state of charge (SOC) of the energy storage units. The SOC of a respective energy storage unit is the ratio of electrical energy stored in the respective energy storage unit compared to the total amount of electrical energy that can be stored in the respective energy storage unit, i.e., the SOC ranges from 0% to 100%. The control unit can be furthermore configured to form the charging set, discharging set, or the charging set and discharging set in dependence of the SOC of the energy storage units. This allows to reduce energy consumption and allows stable operation of the functional device.

The control unit can be configured to select energy storage units to form the charging set in dependence of the SOC of the energy storage units. Energy storage units with a lower SOC can be preferred to be included into the charging set over energy storage units with a higher SOC. The control unit can be configured to monitor the SOC of the energy storage units and to adapt the charging set according to current SOC of the energy storage units. The control unit can be configured to remove energy storage units from the charging set and to add other energy storage units to the charging set, e.g. one of the energy storage units of the charging set that is fully charged can be replaced by a non-fully charged energy storage unit. This allows to improve power conversion efficiency and use of electrical energy. The control unit can furthermore be configured to remove energy storage units from and add energy storage units to the charging set such that the SOC of the energy storage units is balanced. The control unit can be configured to form the charging set such that the energy storage units are charged at the same rate or in time intervals based on the current SOC of the energy storage units and such that the SOC of the energy storage units is balanced. This allows to reduce periods of charging.

The control unit can be configured to select energy storage units to form the discharging set in dependence of the SOC of the energy storage units. Energy storage units with a higher SOC can be preferred to be included into the discharging set over energy storage units with a lower SOC. The control unit can be configured to monitor the SOC of the energy storage units and to adapt the discharging set according to current SOC of the energy storage units. The control unit can be configured to remove energy storage units from the discharging set and to add other energy storage units to the discharging set, e.g. one of the energy storage units of the charging set that is fully depleted can be replaced by an at least partially charged energy storage unit. This allows to improve power conversion efficiency, use of electrical energy and energy storage unit utilization. The control unit can furthermore be configured to remove energy storage units from and add energy storage units to the discharging set such that the SOC of the energy storage units is balanced. The control unit can be configured to form the discharging set such that the energy storage units are discharged at the same rate or in time intervals based on the current SOC of the energy storage units and such that the SOC of the energy storage units is balanced. This allows to extend periods of discharging.

The control unit can be configured to use a simple control scheme to sequentially remove one or more of the energy storage units from the charging set and add the one or more energy storage units to the discharging set for powering the functional unit. The control unit can be configured to include energy storage units in the charging set and the discharging set simultaneously, such that a respective energy storage unit that is in the charging set and the discharging set is charged and discharged simultaneously. Alternatively the control unit can be configured to include a respective energy storage unit only in one of the charging set and the discharging set, such that the respective energy storage unit is either charged or discharged.

The control unit can be configured to switch a set of switches of the arrangement of the switches between open and closed states in order to form the charging set, the discharging set, or the charging set and the discharging set of energy storage units. The set of switches can for example be switched using an electromechanical relay. This allows an easy control of the switching as a set of switches is controlled instead of individually switching the switches.

The discharging set of energy storage units providing the output voltage can be galvanically isolated from the other energy storage units. The arrangement of the switches allows to galvanically isolate the charging and discharging energy storage units from each other. Galvanically isolating the energy storage units from each other allows to prevent unwanted current flow between the energy storage units.

The functional unit can comprise a constant current driver for providing the functional unit with a constant current based on a varying drive voltage. This allows an operation of functional units that require constant current and prevents thermal runaway. The constant current driver can for example be an LED driver. The functional unit can comprise an energy buffer, such as an electrolytic capacitor. The energy buffer allows a smoother takeover.

The functional unit can comprise a lighting unit, an actuation unit, a user interface, a heating unit, a cooling unit, or a temperature regulating unit. The lighting unit can provide light, the actuation unit can provide movement, the user interface can provide a user the possibility to interact, the heating unit can provide heat, the cooling unit can provide cooling, and the temperature regulating unit can provide regulation of temperature.

The energy storage units can comprise a battery, a capacitor, or a battery and a capacitor. The battery is rechargeable. The capacitor can for example be a supercapacitor. If a respective energy storage unit of the energy storage units comprises both battery and capacitor the battery can be used for slow charging and discharging and the capacitor can be used for fast charging and discharging.

The control unit can be configured to perform various operation modes. The control unit can be configured to perform a first operation mode in which currently non discharging energy storage units can be charged, i.e. added to the charging set. Furthermore one or more of the energy storage units of the discharging set can be charged during discharging in the first operation mode, i.e. one or more of the energy storage units of the discharging set can be added to the charging set such that the one or more of the energy storage units are simultaneously charged and discharged. The control unit can be configured to operate in a second operation mode in which currently non discharging energy storage units can be charged and the energy storage units of the discharging set are not charged during discharging. Preferably the energy storage units of the discharging set are galvanically isolated from the other energy storage units in the second operation mode.

The functional device can comprise three different sets of energy storage units simultaneously, namely the charging set, the discharging set, and an idle set. The idle set comprises energy storage units which are neither included in the charging set nor in the discharging set. The energy storage units of the idle set can be added to the charging set or the discharging set when needed.

In a further aspect of the present invention a functional system is presented. The functional system comprises the functional device according to one of the claims 1 to 10 or any embodiment of the functional device. The functional system furthermore comprises the external power source.

The functional system can for example be a battery integrated luminaire system.

In a further aspect of the present invention a method is presented. The method for operating the functional device according to claim 1 comprises the steps:

receiving an input voltage from the external power source,

providing that the charging set of the energy storage units connected in series with each other have a charging set voltage adapted to the input voltage received from the external power source in order to minimize the voltage difference between the input voltage and the converted input voltage,

providing the converted input voltage to the charging set of the energy storage units,

providing that the discharging set of the energy storage units is configured to provide the output voltage adapted to the functional unit input voltage required by the functional unit in order to minimize a voltage difference between the output voltage and the functional unit input voltage, and

providing the output voltage to the functional unit.

The method can further comprise the steps:

forming the charging set in dependence of the input voltage received from the external power source, and

forming the discharging set in dependence of the functional unit input voltage required by the functional unit.

Forming the charging set and discharging set can be performed by switching the switches of the arrangement of the switches. The switches can be switched in dependence of the input voltage received from the external power source and the functional unit input voltage required by the functional unit.

The method can comprise the step

determining the input voltage received from the external power source.

Alternatively or additionally the method can comprise the step

determining the functional unit input voltage required by the functional unit.

The method can comprise the step

determining the SOC of the energy storage units.

Alternatively or additionally the method can comprise the step

forming the charging set, the discharging set, or the charging set and the discharging set in dependence of the SOC of the energy storage units.

The method can comprise the step

providing that the discharging set of the energy storage units is galvanically isolated from the other energy storage units.

The method can comprise the step

performing the function of the functional unit, e.g. in case of a lighting unit light can be provided, in case of an actuation unit movement of an actuator can be provided, in case of a heating unit heat can be provided, or in case of a cooling unit cooling can be provided.

The method can be performed for operating the functional device, e.g. a lighting device, such that the energy storage units are time shifted and sequentially discharged one after another in order to operate the functional unit, e.g. lighting unit comprising an LED for providing light.

The method can be performed with simultaneously charging energy storage units in the charging set and discharging energy storage units in the discharging set independently from each other with galvanic isolation.

In a further aspect of the present invention a computer program for operating the functional device according to claim 1 is presented. The computer program comprises program code means for causing a processor to carry out the method as defined in claim 12 or any embodiment of the method, when the computer program is run on the processor. The computer program can furthermore be configured to operate the functional system according to claim 11.

In a further aspect a computer-readable medium having stored the computer program of claim 14 is presented. Alternatively or additionally the computer-readable medium can have the computer program according to any embodiment of the computer program stored.

It shall be understood that the functional device of claim 1, the functional system of claim 11, the method for operating the functional device of claim 12, the computer program of claim 14, and the computer-readable medium of claim 15 have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically and exemplarily a first embodiment of a functional device in a first embodiment of a functional system in charging mode;

FIG. 2 shows schematically and exemplarily the first embodiment of the functional device in the first embodiment of the functional system in simultaneous charging and discharging mode;

FIG. 3 shows schematically and exemplarily a second embodiment of the functional device in a second embodiment of the functional system;

FIG. 4 shows schematically and exemplarily a third embodiment of the functional device in a third embodiment of the functional system;

FIG. 5 shows schematically and exemplarily a part of an embodiment of the functional device with an exemplary switch arrangement;

FIG. 6 shows a diagram of buck converter efficiency in dependence of output current for various input voltages;

FIG. 7 shows an embodiment of the method for operating the functional device.

### DETAILED DESCRIPTION OF EMBODIMENTS

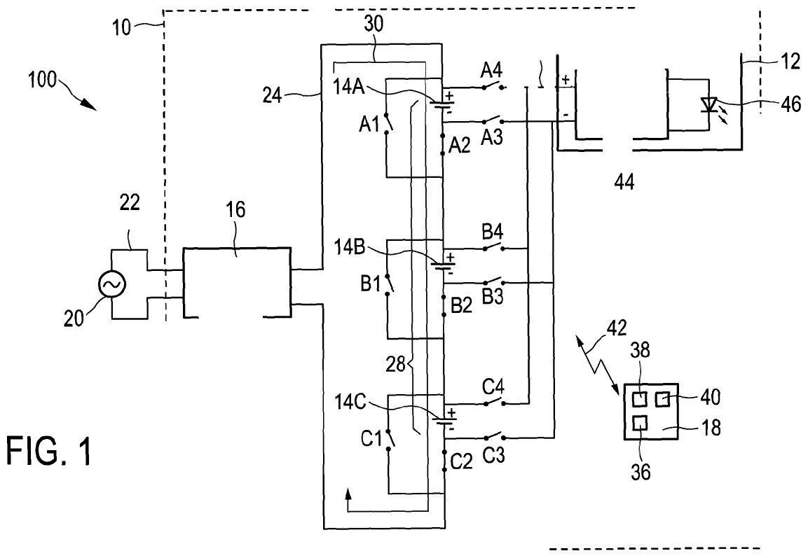

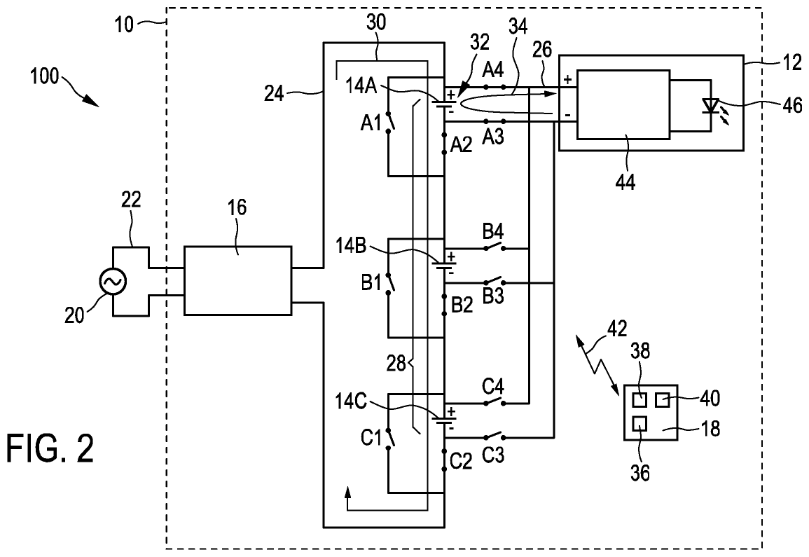

FIG. 1 and FIG. 2 show schematically and exemplarily a first embodiment of a functional device in form of a lighting device 10 in a first embodiment of a functional system in form of a lighting system 100. In other embodiments the functional device can be an actuation device, a user interface device, a heating device, a cooling device, or a temperature regulating device and the functional system can be a corresponding actuation system, user interface system, heating system, cooling system, or temperature regulating system.

The lighting device 10 comprises a functional unit in form of a lighting unit 12, three energy storage units in form of batteries 14A, 14B, and 14C, an electric power converter unit in form of a buck PFC converter 16, and a control unit 18. The lighting device 10 can also comprise any other number of batteries, e.g. 10 or 20. In other embodiments the functional device can comprise an actuation unit, a user interface, a heating unit, a cooling unit, a temperature regulating unit or any other functional unit.

The lighting system 100 comprises the lighting device 10 and an external power source in form of the mains electrical power supply 20. The mains electrical power supply provides AC with a voltage of 120 V in this embodiment corresponding to 170 V DC voltage. The mains electrical power supply can be replaced by any other external power source in other embodiments. The lighting device 10 is connected to the mains electrical power supply 20 via wire 22.

The lighting unit 12, the batteries 14A, 14B, and 14C, and the buck PFC converter 16 are connected via electric circuitry. Wire 24 connects the buck PFC converter 16 with the batteries 14A, 14B, and 14C, and wire 26 connects the batteries 14A, 14B, and 14C with the lighting unit 12. The electric circuitry comprises an arrangement of switches A1, A2, A3, A4, B1, B2, B3, B4, C1, C2, C3, and C4. In this embodiment 4 switches are provided for each of the batteries 14A, 14B, and 14C to close and open connections in the electric circuitry.

Battery 14A is operated by switches A1, A2, A3, and A4, battery 14B is operated by switches B1, B2, B3, and B4, and battery 14C is operated by switches C1, C2, C3, and C4. Switches A2, B2, and C2 are in a closed state in FIG. 1 while all other switches are in an open state. Thus batteries 14A, 14B, and 14C are connected in series with each other and form a charging set 28. In this embodiment the charging set 28 includes all batteries of the lighting device 10. In other embodiments the functional device can comprise another number of energy storage units and the charging set can be a subset of the energy storage units of the functional device.

The batteries 14A, 14B, and 14C are of the same type and have the same voltage in this embodiment. The voltage of the batteries in this embodiment is 50 V, such that the three batteries connected in series have a voltage of 150 V. In other embodiments the voltage of the batteries can for example be 6 V or 12 V and the number of batteries can for example be 10 or 20.

The buck PFC converter 16 is connected to the mains electrical power supply 20 and receives the input voltage of 120 V AC via the wire 22. The buck PFC converter 16 converts the AC with 120 V with 90% buck PFC converter duty cycle corresponding to 153 V DC to a converted input voltage of 153 V DC which the buck PFC converter 16 provides to the charging set 28 via wire 24 along current flow direction 30 for the charging process. The charging set voltage is 150 V, i.e., the sum of the voltages of the three batteries 14A, 14B, 14C connected in series with each other. The charging set voltage is adapted to the input voltage of 153 V DC received from the mains electrical power supply 20. This allows to minimize a voltage difference between the input voltage and the converted voltage and therefore allows to improve the power conversion efficiency.

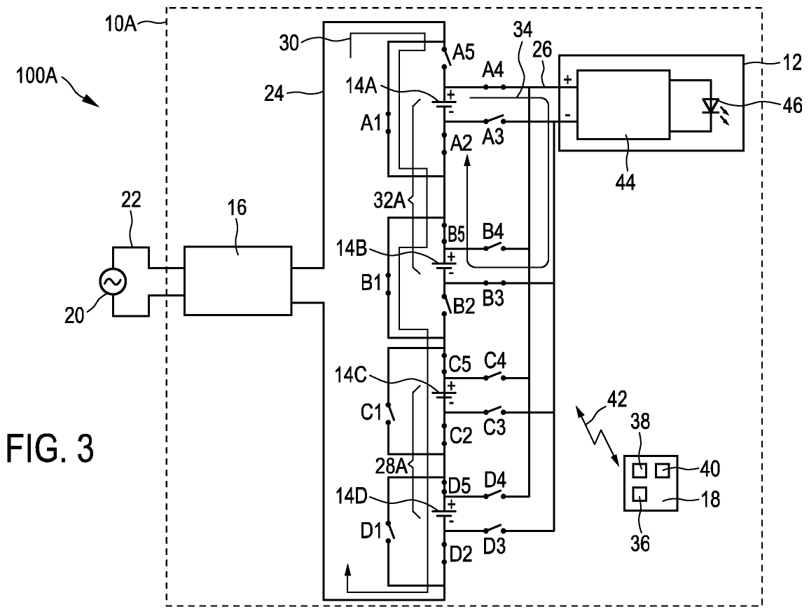

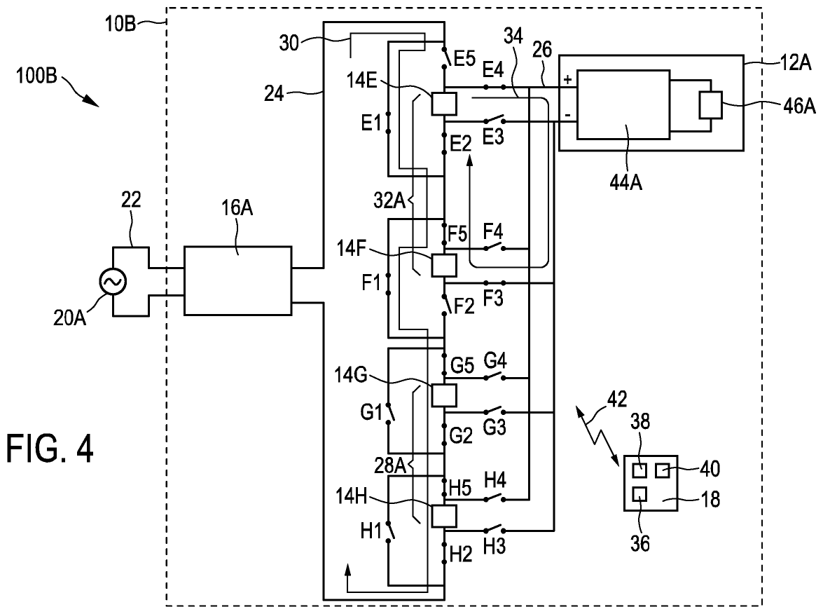

In FIG. 1 the lighting unit 12 is not powered, as switches A3, A4, B3, B4, C3, and C4 are in the open state. In FIG. 2 the switches A3 and A4 are in the closed state and the lighting unit 12 is powered with output voltage of a discharging set 32 formed by battery 14A. In FIG. 2 battery 14A is included in the charging set 28 and the discharging set 32 and charged and discharged simultaneously. The output voltage is provided from the discharging set 32 to the lighting unit 12 via the wire 26 along current flow direction 34 for the discharging process. The discharging set 32 in this embodiment includes only battery 14A and has the output voltage of 50 V. In other embodiments the discharging set can include more than one battery. If more than one battery is included in the discharging set another switch arrangement is required as can be seen in the embodiments of FIGS. 3 and 4. If more than one battery is included in the discharging set, the batteries of the discharging set are connected in series and have an output voltage corresponding to the sum of voltages of the batteries. The output voltage of the discharging set 32 is adapted to functional unit input voltage required by the lighting unit 12. The lighting unit 12 requires 50 V for operation in this embodiment of the lighting device 10. This allows to minimize a voltage difference between the output voltage and the functional unit input voltage and therefore allows to improve the power conversion efficiency.

The switching of the switches A1, A2, A3, A4, B1, B2, B3, B4, C1, C2, C3, and C4 is controlled by control unit 18. Control unit 18 comprises a processor 36, a transceiver 38, and a memory 40. The processor 36 generates control signals 42 that can be transmitted wirelessly via the transceiver 38 to the switches A1, A2, A3, A4, B1, B2, B3, B4, C1, C2, C3, and C4 for controlling the switching of the switches between open state and closed state. In this embodiment each of the switches A1, A2, A3, A4, B1, B2, B3, B4, C1, C2, C3, and C4 has an antenna for receiving the control signals 42. The respective switch switches in dependence of the received control signal. In other embodiments sets of switches can comprise an antenna and the switches can be switched together in dependence of the control signal. In yet other embodiments the control unit can be connected to the switches via wires in order to send control signals. The switching between open and closed states of the switches allows to form charging set and discharging set.

The memory 40 comprises a computer program for operating the lighting device 10.

In this embodiment the control unit 18 determines the input voltage received from the mains electrical power supply 20 and the functional unit input voltage required by the lighting unit 12. The control unit 18 uses the determined input voltage and functional unit input voltage in order to control the switching of the switches A1, A2, A3, A4, B1, B2, B3, B4, C1, C2, C3, and C4.

Furthermore the control unit 18 determines a SOC of each of the energy storage units 14A, 14B, and 14C and forms the discharging set in dependence of the SOC of the energy storage units 14A, 14B, and 14C. In other embodiments the control unit 18 can also form the charging set in dependence of the SOC of the energy storage units.

The lighting unit 10 comprises a constant current driver in form of an LED driver 44 and an LED module 46. The LED driver 44 provides a constant current to the LED module 46 by varying a drive voltage. The LED module 46 provides light when it is powered with its forward voltage.

The arrangement of switches and batteries is easily scalable which allows to use another number of batteries with other voltages as well as other functional units and external power sources. In another embodiment a functional device can have a large number of batteries and only part of the batteries can form the charging set while other batteries are idle and belong to an idle set.

FIG. 3 shows schematically and exemplarily a second embodiment of the functional device in form of a lighting device 10A in a second embodiment of the functional system in form of a lighting system 100A.

In contrast to the lighting device 10, the lighting device 10A includes an additional battery 14D and additional switches A5, B5, C5, as well as switches D1, D2, D3, D4, and D5. Additional switches A5, B5, C5, and D5 of lighting device 10A in contrast to lighting device 10 allow to form a discharging set of more than one battery. In the embodiment presented in FIG. 3 closed switches A4, A2, B5, and B2 allow to form the discharging set 32A with two batteries. In FIG. 3 the discharging set 32A includes batteries 14A and 14B. The charging set 28A is formed by batteries 14C and 14D in this embodiment. The mains electrical power supply provides 120 V DC in this embodiment and the batteries each have a voltage of 50 V. The lighting unit 12 requires a functional unit input voltage of 60 V.

The lighting device 10A operates such that the batteries can only be included in either the charging set or the discharging set, i.e., a specific battery can only be charged or discharged, but the specific battery cannot be simultaneously charged and discharged. Charging of the charging set 28A, however, is performed simultaneously to discharging the discharging set 32A. In other embodiments charging and discharging of one or more energy storage units can be performed simultaneously, i.e., one or more energy storage units can in other embodiments be in the charging set and discharging set simultaneously. The batteries 14A and 14B of the discharging set 32A in this embodiment are galvanically isolated from the other batteries 14C and 14D. This allows PFC buck converter 16 to block electromagnetic interference (EMI) generated by LED driver 44.

The discharging can be performed for the discharging set 32A such that at first batteries 14A and 14B are discharged until they are depleted and then batteries 14C and 14D are discharged while batteries 14A and 14B are charged. A1ternatively the charging set 28A and the discharging set 32A can be discharged at the same rate or in time intervals. The switching of the switches in order to form the charging set 28A and the discharging set 32A can depend on a current SOC of the batteries 14A, 14B, 14C, and 14D. This allows to achieve better power conversion efficiency in the lighting device 10A.

FIG. 4 shows schematically and exemplarily a third embodiment of the functional device in form of an actuation device 10B in a third embodiment of the functional system in form of an actuation system 100B. The actuation system 100B in this embodiment is a part of an electric car. The actuation system 100B is similar to the lighting system 100A. In contrast to the lighting system 100A, the actuation system 100B includes the actuation device 10B and is connected to a battery storage system 20A of the electric car.

The actuation device 10B includes a functional unit in form of a DC electric motor 12A, energy storage units in form of supercapacitors 14E, 14F, 14G, and 14H, an electric power converter unit in form of a SMPS 16A, and a control unit 18. In other embodiments the supercapacitors can be replaced by any other type of capacitor or by batteries or by batteries and capacitors.

The actuation system 100B functions essentially the same as described for the other embodiments with the difference that supercapacitors 14E, 14F, 14G, and 14H are used for storing electrical energy and DC electric motor 12A is powered. The actuation system 100B has switches E1, E2, E3, E4, E5, F1, F2, F3, F4, F5, G1, G2, G3, G4, G5, H1, H2, H3, H4, and H5 that are controlled by control unit 18. DC electric motor 12A comprises a constant current driver 44A that provides constant current to actuation element 46A.

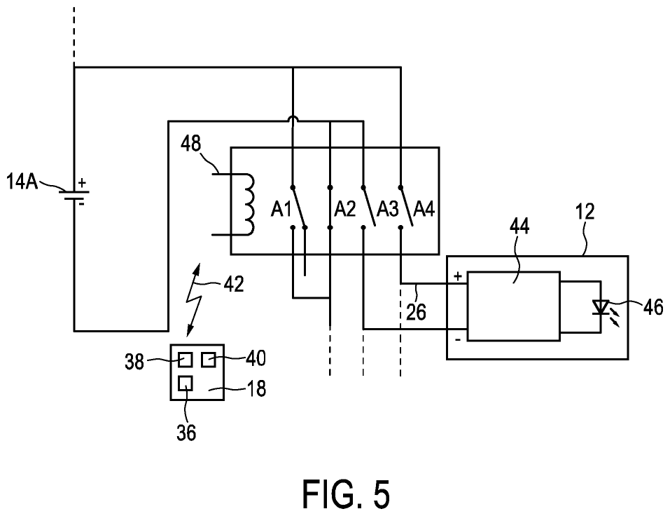

FIG. 5 shows schematically and exemplarily a part of an embodiment of the functional device with an exemplary switch arrangement for better understanding while the wires leading to the remainder of the functional device are only indicated by dashed lines. The switch arrangement uses electromechanical relays with four switches A1, A2, A3, and A4, as well as coil 48. Electromechanical relays can for example be implemented in the first embodiment of the functional device as presented in the FIGS. 1 and 2. Furthermore relays with multiple NO and NC contacts can be used to implement the concept easily in any embodiment of the functional device. The relays can be single relays or two relays with multiple NO and NC contacts.

In this embodiment the position of switch A2 is complementary to the positions of the other switches A1, A3, and A4. Battery 14A is included in the charging set if switch A2 is closed and is included in the discharging set if switches A1, A3, and A4 are closed. Switch A2 is NC and switches A1, A3, and A4 are NO, such that the battery 14A is normally in the charging set and charged. The four switches A1, A2, A3, and A4 are simultaneously switched using coil 48. Coil 48 is provided with control signals 42 wirelessly from the control unit 18. If the coil 48 receives the control signal 42 it attracts the switches A1, A2, A3, and A4 such that switch A2 opens and switches A1, A3, and A4 close, such that the battery 14A is added to the discharging set and discharges in order to power the lighting unit 12.

In other embodiments the relay logic can also be implemented such that switch A2 is NO and switches A1, A3, and A4 are NC, i.e. in this case the battery is normally in the discharging set and discharging in order to power the lighting unit.

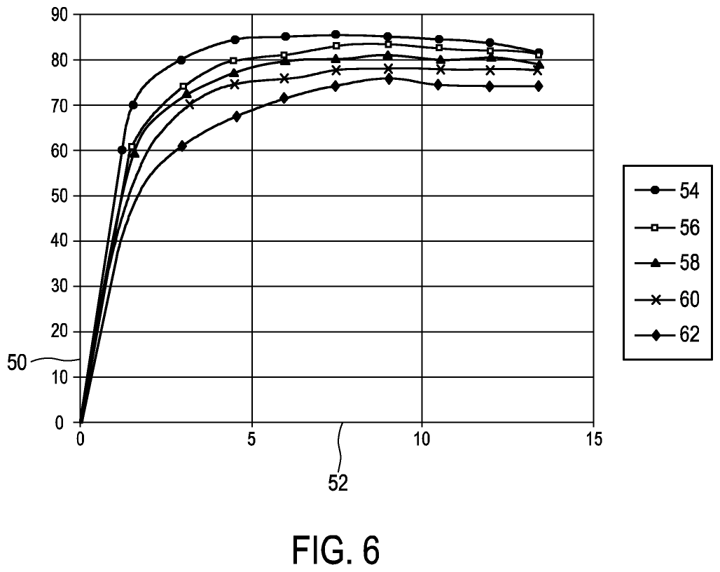

FIG. 6 shows a diagram of buck converter efficiency 50 in dependence of output current 52 for various DC input voltages 54, 56, 58, 60 and 62. The output voltage provided by the buck converter is 12 V. The input voltage 54 is 18 V, the input voltage 56 is 22 V, the input voltage 58 is 26 V, the input voltage 60 is 30 V, and the input voltage 62 is 36 V. The buck converter efficiency 50 decreases with increasing input voltage, i.e. the buck converter efficiency 50 decreases with increasing difference between input voltage and output voltage. Maximum buck converter efficiency 50 is achieved for an input voltage to output voltage ratio of close to 1.

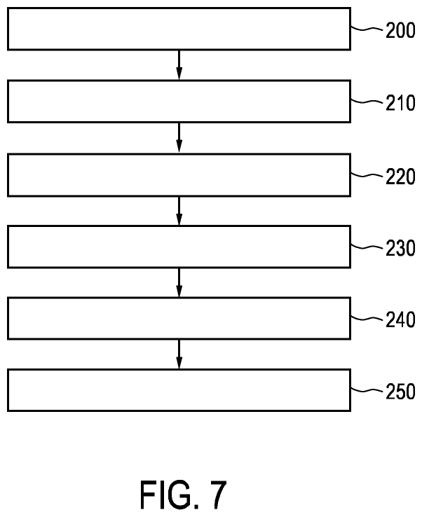

FIG. 7 shows an embodiment of the method for operating the functional device. The functional device can be a lighting device, an actuation device, a heating device, a cooling device or any other functional device. In this embodiment the functional device is a lighting device. The lighting device comprises a functional unit in form of a lighting unit, twenty energy storage units in form of twenty batteries, an electric power converter unit in form of a buck PFC converter, a control unit, electric circuitry and an arrangement of switches. The lighting device can be connected to an external power source. In this embodiment the lighting device is connected to an electrical power supply providing 240 V DC. The electric circuitry connects the lighting unit, batteries and buck PFC converter. The buck PFC converter converts input voltage received from the electrical power supply to converted input voltage. In this embodiment each of the batteries provides 12 V. The lighting unit has an LED driver and an LED module provided with constant current from the LED driver. The LED driver varies a drive voltage in order to provide the constant current. The LED driver requires a functional unit input voltage of 40 V for operating the LED module. The control unit can be used to control the arrangement of the switches.

In step 200 an input voltage is received from the electrical power supply.

In step 210 it is provided that a charging set of the batteries connected in series with each other have a charging set voltage adapted to the input voltage received from the electrical power supply in order to minimize a voltage difference between the input voltage and the converted input voltage. In this embodiment the switches are switched such that the charging set of batteries is formed with an output voltage that is below and as close as possible to the input voltage received from the electrical power supply. A1l twenty batteries are included in the charging set and the twenty batteries have a charging set voltage of 240 V.

In step 220 the converted input voltage is provided to the charging set of the batteries.

In step 230 it is provided that the discharging set of the batteries is configured to provide the output voltage adapted to the functional unit input voltage required by the lighting unit in order to minimize a voltage difference between the output voltage and the functional unit input voltage. In this embodiment the switches are switched such that the discharging set is formed that provides an output voltage that is above and as close as possible to the functional unit input voltage required by the lighting unit. The discharging set is formed from four batteries that have output voltage of 48 V.

In step 240 the output voltage is provided to the LED driver of the lighting unit.

In step 250 a function of the lighting unit is performed. The function depends on the functional unit which is operated. In this embodiment the functional unit is a lighting unit with LED module. The function of the lighting unit is providing light. In other embodiments the functional unit can be for example an actuation unit that provides movement of an actuator, a heating unit that provides heat, or a cooling unit that provides cooling.

Forming the charging set and discharging set can be performed by switching the switches of the arrangement of the switches. The switches can be switched in dependence of the input voltage received from the electrical power supply and the functional unit input voltage required by the lighting unit.

In other embodiments of the method step 210 includes determining the input voltage received from the electrical power supply. Alternatively or additionally step 230 can include determining the functional unit input voltage required by the lighting unit. Furthermore steps 210 and 230 can include determining the SOC of the energy storage units. The charging set, the discharging set, or the charging set and the discharging set can be formed in dependence of the SOC of the energy storage units. In other embodiments it can be provided that the discharging set of the energy storage units is galvanically isolated from the other energy storage units.

While the invention has been illustrated and described in detail in the drawings and foregoing description, such illustration and description are to be considered illustrative or exemplary and not restrictive; the invention is not limited to the disclosed embodiments. For example, it is possible to operate the invention in an embodiment wherein the functional unit input voltage required by the functional unit is higher than an input voltage received from the external power source. In this case the number of energy storage units can be large enough in order to allow forming of a discharging set of the energy storage units that is configured to provide an output voltage adapted to the functional unit input voltage to the functional unit in order to minimize a voltage difference between the output voltage and the functional unit input voltage. For example the functional unit can be an LED module requiring 120 V functional unit input voltage and the external power source can be configured to provide 40 V input voltage. Therefore the energy storage units, e.g. ten or more 12 V batteries, can be charged sequentially with the 40 V input voltage, e.g., sequentially charging three batteries in series with 36 V, and the functional device can be operated using the energy storage units connected in series in order to provide 120 V output voltage, e.g., connecting ten batteries in series. The electric power converter unit can for example be a boost or buck-boost PFC converter in this case that keeps boost factor as low as possible, i.e. close to 1, for maximum efficiency.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit, processor, or device may fulfill the functions of several items recited in the claims. The mere fact that certain measures are recited in mutually different dependent claims does not indicate that a combination of these measures cannot be used to advantage.

Operations like receiving an input voltage from the external power source, providing that the charging set of the energy storage units connected in series with each other have a charging set voltage adapted to the input voltage received from the external power source, providing the converted input voltage to the charging set of the energy storage units, providing that the discharging set of the energy storage units is configured to provide the output voltage adapted to the functional unit input voltage required by the functional unit, providing the output voltage to the functional unit, forming the charging set, forming the discharging set, et cetera performed by one or several units or devices can be performed by any other number of units or devices. These operations and/or the method can be implemented as program code means of a computer program and/or as dedicated hardware.

A computer program may be stored/distributed on a suitable medium, such as an optical storage medium, or a solid-state medium, supplied together with or as part of other hardware, but may also be distributed in other forms, such as via the Internet, Ethernet, or other wired or wireless telecommunication systems.

Any reference signs in the claims should not be construed as limiting the scope.

The present invention relates to a functional device with improved power conversion efficiency. The functional device comprises a functional unit, two or more energy storage units, and an electric power converter unit. The electric power converter unit is configured to receive an input voltage from an external power source and to provide converted input voltage to a charging set of the energy storage units which are connected in series with each other having a charging set voltage adapted to the input voltage received from the external power source. A discharging set of the energy storage units is configured to provide an output voltage adapted to a functional unit input voltage required by the functional unit to the functional unit. This allows an improved power conversion efficiency.

1. A functional device comprising:
a functional unit for performing a function,
two or more energy storage units configured for storing electrical energy, and
an electric power converter unit configured to be connected to an external power source, to receive an input voltage from the external power source and to provide converted input voltage to a charging set of the energy storage units which are connected in series with each other having a charging set voltage adapted to the input voltage received from the external power source in order to minimize a voltage difference between the input voltage and the converted input voltage, wherein a discharging set of the energy storage units is configured to provide an output voltage adapted to a functional unit input voltage required by the functional unit to the functional unit in order to minimize a voltage difference between the output voltage and the functional unit input voltage; wherein the number of energy storage units in the charging set is different compared to the number of energy storage units in the discharging set, and wherein the functional device comprises electric circuitry for connecting the functional unit, the energy storage units and the electric power converter unit and an arrangement of switches which is configured to form the charging set, the discharging set, or the charging set and the discharging set of the energy storage units in dependence of open and closed states of switches.

2. (canceled)

3. The functional device according to claim 1, comprising a control unit configured to control switching of the switches in order to form the charging set in dependence of the input voltage received from the external power source, the discharging set in dependence of the functional unit input voltage required by the functional unit or the charging set and the discharging set of the energy storage units in dependence of the input voltage received from the external power source and the functional unit input voltage required by the functional unit.

4. The functional device according to claim 3, wherein the control unit is configured to determine the input voltage received from the external power source, the functional unit input voltage required by the functional unit, or the input voltage received from the external power source and the functional unit input voltage required by the functional unit in order to control the switching of the switches.

5. The functional device according to claim 4, wherein the control unit is configured to determine a state of charge of the energy storage units and to form the charging set, the discharging set, or the charging set and the discharging set in dependence of the state of charge of the energy storage units.

6. The functional device according to claim 5, wherein the control unit is configured to switch a set of switches of the arrangement of the switches between open and closed states in order to form the charging set, the discharging set, or the charging set and the discharging set of the energy storage units.

7. The functional device according to claim 6, wherein the discharging set of the energy storage units providing the output voltage is galvanically isolated from the other energy storage units.

8. The functional device according to claim 7, wherein the functional unit comprises a constant current driver for providing the functional unit with a constant current based on a varying drive voltage.

9. The functional device according to claim 8, wherein the functional unit comprises a lighting unit, an actuation unit, a user interface, a heating unit, a cooling unit, or a temperature regulating unit.

10. The functional device according to claim 9, wherein the energy storage units comprise a battery, a capacitor, or a battery and a capacitor.

11. A functional system comprising the functional device according to claim 1 and the external power source.

12. A method for operating the functional device according to claim 1 comprising the steps:
receiving an input voltage from the external power source,
providing that the charging set of the energy storage units connected in series with each other have a charging set voltage adapted to the input voltage received from the external power source in order to minimize the voltage difference between the input voltage and the converted input voltage,
providing the converted input voltage to the charging set of the energy storage units,
providing that the discharging set of the energy storage units is configured to provide the output voltage adapted to the functional unit input voltage required by the functional unit in order to minimize a voltage difference between the output voltage and the functional unit input voltage; wherein the number of energy storage units in the charging set is different compared to the number of energy storage units in the discharging set, and wherein the functional device comprises electric circuitry for connecting the functional unit, the energy storage units and the electric power converter unit and an arrangement of switches which is configured to form the charging set, the discharging set, or the charging set and the discharging set of the energy storage units in dependence of open and closed states of switches; and
providing the output voltage to the functional unit.

13. The method according to claim 12 further comprising the steps:
forming the charging set in dependence of the input voltage received from the external power source, and
forming the discharging set in dependence of the functional unit input voltage required by the functional unit.

14. A computer program for operating the functional device according to claim 1.

15. A computer-readable medium having stored the computer program of claim 14.
